(19) United States
(12) Patent Application Publication
(10) Pub. No.: US 2004/0207508 A1
(43) Pub. Date: Oct. 21, 2004

(54) Method and apparatus for a dynamically customizable smart phonebook

(76) Inventors: Jyh-Han Lin, Coral Springs, FL (US); Yong C. Lee, Plantation, FL (US); Geydi Lorenzo, Miramar, FL (US); Anand V. Patel, Jupiter, FL (US); William N. Saez, Plantation, FL (US)

Correspondence Address: AKERMAN SENTERFITT, P.O. BOX 3188, WEST PALM BEACH, FL, 33402-3188, US

(21) Appl. No.: 10/414,697

(22) Filed: Apr. 16, 2003

(51) Int. Cl. H04M 1/64

(52) U.S. Cl. 340/5.1; 379/67.1; 455/564

(57) ABSTRACT

A communication device (10) having a smart phonebook (14) and a method (50) of customizing device functionality using the smart phone book includes a transceiver (38 and 44), a memory (32) having at least one phonebook data entry called a PhoneLet 24 and at least one encapsulated data entry (29) associated with the phonebook data entry, and a processor (12) coupled to the transceiver. The processor can be programmed to dynamically customize at least one program running in the communication device and to dynamically customize data associated with the at least one program based on the calling up of the at least one phonebook data entry and based on the at least one encapsulated data entry. The smart phonebook can include a smart phonebook manager (16) and a plurality (20) of PhoneLets.

### CROSS-REFERENCE TO RELATED APPLICATIONS

Not applicable

### FIELD OF THE INVENTION

This invention relates generally to electronic phonebooks, and more particularly to a method and system for creating a dynamically customizable communication device based on an entry in the phonebook.

### BACKGROUND OF THE INVENTION

More and more customizations are being enabled for newer generations of mobile handsets. End users can now customize ring tones, wallpapers, and other functions. Currently, end users are not able to customize device behaviors based on a one-to-one relationship between the parties communicating. For example, the call interfaces and helper functionality for a call to a business associate is the same as the call interfaces and helper functionality for a call to a family member.

An exemplary reference illustrating the state of the art includes U.S. Pat. No. 6,427,064 to Daniel A. Henderson which discusses using static data, not dynamic programs in an invention entitled “Method and Apparatus For Maintaining a Database in a Portable Communication Device.”

U.S. Pat. No. 6,445,694 discusses an internet controlled telephony system employing a host services processor connected to a subscriber via the internet and further connected to a public switched telephone system (PSTN). The subscriber uses a web interface to populate a database with preference data which is used by the host services processor to handle incoming calls and establish outgoing telephone connections in accordance with preference data provided by the subscriber. Again, this system does not provide for dynamic customization of both program and data at a subscriber unit.

### SUMMARY OF THE INVENTION

A method and apparatus for providing dynamic customization of both programs and data can use a new architecture that can transform static data to a dynamic program using what is termed herein as a Smart Phonebook using for example Java based applications. This new architecture will enable end users to dynamically customize device behaviors based on one-to-one (or one-to-group) relationships between communicating parties.

In a first aspect of the present invention, a communication device having a smart phonebook can include a transceiver, a memory having at least one phonebook data entry and at least one encapsulated data entry associated with the phonebook data entry, and a processor coupled to the transceiver. The processor can be programmed to dynamically customize at least one program running in the communication device and to dynamically customize data associated with the at least one program based on the calling up of the at least one phonebook data entry and based on the at least one encapsulated data entry in the phonebook data entry.

In a second aspect of the present invention, a smart phonebook for use in a communication device can include an application used as an entry for each separate phonebook entry in the smart phonebook and a smart phonebook manager having a graphical user interface enabling at least one or more of the functions selected from the group comprising adding an entry, deleting an entry, sorting a plurality of entries, updating an entry, sending an entry to another communication device, receiving an entry from another communication device, synchronizing an entry with another device, searching an entry by fields and attributes, starting an entry to make a call, starting an entry when receiving a call, starting a call forwarding among a plurality of entries, or starting a multi-way conference call among a plurality of entries.

In a third aspect of the present invention, a method of using a smart phonebook for a communication device can include the steps of creating an application as an entry for each separate phonebook entry in the smart phonebook and accessing a smart phonebook manager having a graphical user interface enabling at least one or more of the functions selected from the group comprising adding an entry, deleting an entry, sorting a plurality of entries, updating an entry, sending an entry to another communication device, receiving an entry from another communication device, synchronizing an entry with another device, searching an entry by fields and attributes, starting an entry to make a call, starting an entry when receiving a call, starting a call forwarding among a plurality of entries, and starting a multi-way conference call among a plurality of entries. Another aspect of the present invention can be a machine readable storage having stored thereon a computer program for causing a machine to perform the steps described in the third aspect.

In a fourth aspect of the present invention a method of customizing mobile phone device functionality based upon peer-to-peer coupling using for example a Java-based smart phonebook can include the steps of receiving a call accessing a Java-based applet associated with the call among a plurality of Java-based applets forming the Java-based smart phonebook and executing the Java-based applet to create a customized user interface, application logic, and data while the call associated with the Java-based applet is active. A final aspect of the present invention can be a machine readable storage having stored thereon a computer program for causing a machine to perform the steps described in this fourth aspect.

### BRIEF DESCRIPTION OF THE DRAWINGS

FIG. 1 illustrates a block diagram of a communication device having a smart phonebook in accordance with the present invention

FIG. 2 is a block diagram illustrating a smart phonebook having a PhoneLet Manager and a PhoneLet in accordance with the present invention.

FIG. 3 illustrates a flow chart of a method of customizing mobile phone device functionality in accordance with the present invention.

### DETAILED DESCRIPTION OF THE DRAWINGS

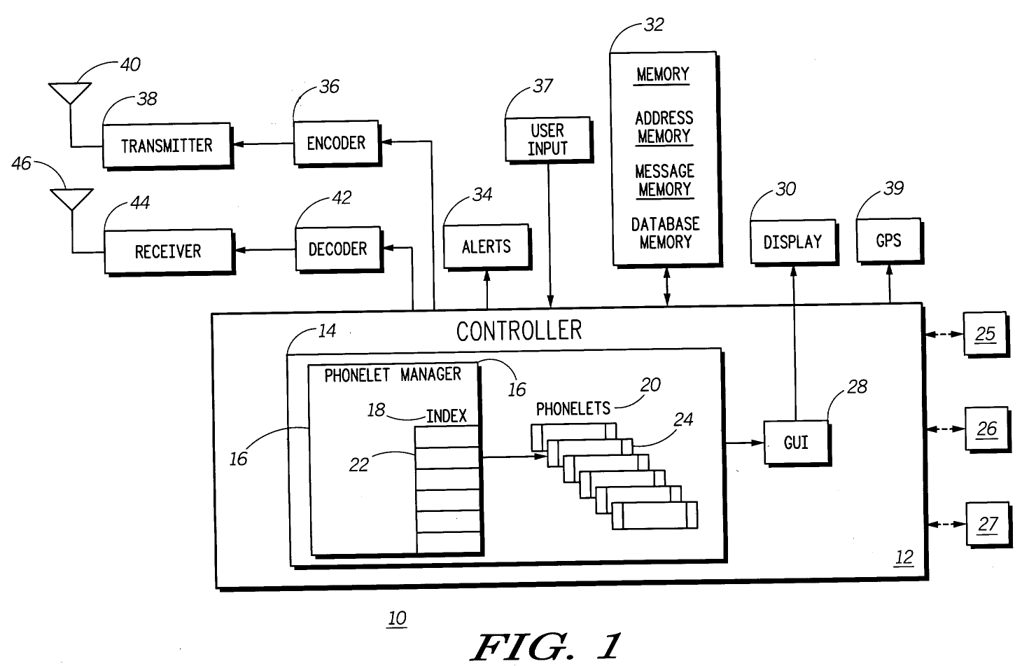

Referring to FIG. 1, a block diagram of a portable communication device 10 can comprise a conventional cellular phone, a two-way trunked radio, a combination cellular phone and personal digital assistant, a smart phone, a home cordless phone, a satellite phone or even a wired phone having a Smart Phonebook feature in accordance with the present invention. In this particular embodiment, the portable communication device 10 can include an encoder 36, transmitter 38 and antenna 40 for encoding and transmitting information as well as an antenna 46, receiver 44 and decoder 42 for receiving and decoding information sent to the portable communication device 10. The device 10 can further include an alert 34, memory 32, a user input device 37 (such as a keyboard, mouse, voice recognition program, etc.), a location device (such as GPS 39), and a display 30 for at least displaying a Smart Phonebook 14 or a Smart Phonebook Manager 16 as will be further detailed below. The device 10 can further include a processor or controller 12 coupled to the display 30, the encoder 36, the decoder 42, the alert 34, the user input 37 and the memory 32. The memory 32 can include address memory, message memory, and memory for database information or for the smart phonebook entries. The smart phonebook can reside in external memory (32) or in internal memory within the processor 12 as shown. The phonebook can include at least one phonebook data entry and at least one encapsulated data entry associated with the phonebook data entry.

The processor 12 is preferably programmed to dynamically customize at least one program running in the communication device 10 and to dynamically customize data associated with the (at least one) program based on the calling up of at least one phonebook data entry and based on at least one encapsulated data entry (associated with the phonebook data entry). The processor 12 can be programmed to include a Smart Phonebook 14 which can comprise at least one application used as a phonebook entry and designated herein as a PhoneLet 24 as shown in FIG. 1. The Smart Phonebook 14 would typically include a plurality 20 of Phonelets. In an exemplary embodiment, the application used as the phonebook entry can be a Java-based application although other language-based applications are contemplated within the scope of the present invention.

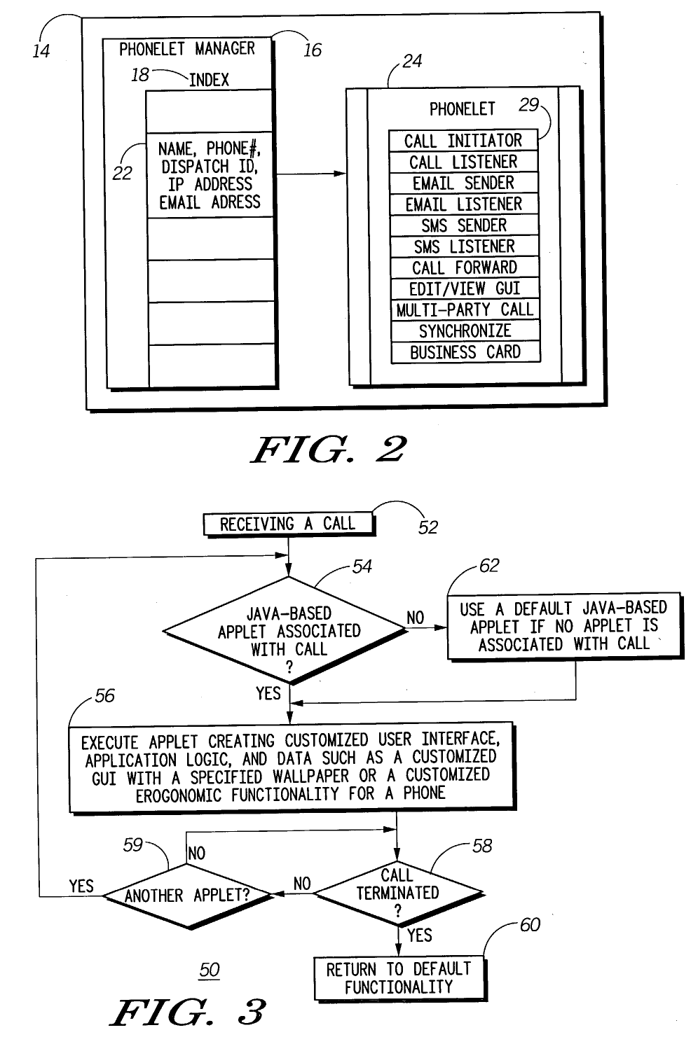

The Smart Phonebook 14 can also include a Smart Phonebook Manager 16 that uses a graphical user interface 28, an index 28 of pointers 22 to individual PhoneLets to enable a user to initiate one or more of the editing, viewing or managerial functions selected from the group comprising adding an entry, deleting an entry, sorting a plurality of entries, updating an entry, sending an entry to another communication device, receiving an entry from another communication device, synchronizing an entry with another device, searching an entry by fields and attributes, starting an entry to make a call, starting an entry when receiving a call, starting a call forwarding among a plurality of entries, and starting a multi-way conference call among a plurality of entries. As shown in FIG. 2, the pointer 22 can enable searching fields by name, phone number, dispatch identification, internet protocol address or email address as examples. Of course, the present invention is not limited to such functions or search fields, but can reasonably include others contemplated for use in conjunction with the communication device 10. The graphical user interface 28 can be used to easily edit a phonebook data entry or Phonelet and the associated encapsulated data entry within the Phonelet.

The PhoneLets 20 or the applications such as Java based applications can further include among other functions at least one function selected from the group of functions comprising starting an interconnect call, receiving an interconnect call when notified by the smart phonebook manager, starting a dispatch call, receiving a dispatch call when notified by the smart phonebook manager, sending an email, receiving an email when notified by the smart phonebook manager, sending a short message, receiving a short message when notified by the smart phonebook manager, call forwarding to another entry, and receiving a call forwarding from another entry when requested.

Referring to FIG. 2, each PhoneLet such as PhoneLet 24 can encapsulate at least one or more attributes or fields 29 among a user interface, application logic for the communication device, data for making calls, data for receiving calls, data for sending messages, data for receiving messages, data for initiating a multi-way call, data for receiving a multi-way call, data for initiating an interconnect call, data for receiving an interconnect call, data for initiating a dispatch call, data for receiving a dispatch call, data for exchanging business card information, and data for synchronizing. The communication device 10 can synchronize an entry with at least one other device such as a server 25, a computer running a desktop application 26, or another mobile communication device 27 via packet data as shown in FIG. 1.

Operationally, a user making a call would select a particular PhoneLet associated with the party being called. A default PhoneLet can automatically be associated and set up with any phone number not listed in the smart phonebook 14 (and then subsequently customized by the user if desired). When receiving a call, a PhoneLet associated with the caller will be automatically started to make the call and perform the other functions designated by the PhoneLet. Caller identification can be used to initiate such a PhoneLet. As with user initiated calls, a default PhoneLet can pick up a call if the caller's phone number or name (from Caller ID) is not in the Smart Phonebook. In this context, it should be understood that “receiving a call” can mean receiving an inbound call from another device when initiating a PhoneLet by means of Caller ID or even voice recognition of the calling party or by receiving user input for initiating an outbound call by a user of the communication device 10.

Referring to FIG. 4, a flowchart illustrating a method 50 of customizing mobile phone device functionality based upon peer-to-peer coupling using a smart phonebook such as a Java-based smart phonebook is shown. The method 50 begins at step 52 by receiving a call accessing a Java-based applet associated with the call among a plurality of Java-based applets forming the Java-based smart phonebook. As mentioned above, “receiving a call” can involve extracting data from caller identification information when receiving a phone call or extracting data from user input when a user is attempting to initiate a phone call. At decision block 54, it is determined if a Java-based applet is present associated with the received call. If no Java-based applet or PhoneLet is available associated with the received call among the plurality of Java-based applets forming the Java-based smart phonebook, then at step 62 a default Java-based applet is accessed and executed.

If a Java-based applet or PhoneLet is available at decision block 54, then such Java-based applet is used to create a customized user interface, application logic, and data while the call associated with the Java-based applet is active at step 56. The Java-based applet can create a customized ergonomic functionality for the mobile phone device such as a customized graphical user interface having a specified wallpaper associated with the Java-based applet or a particular ring tone or background music. Each PhoneLet among the plurality of PhoneLets can provide a unique environment specified by the user. The method continues by monitoring if the call is terminated at decision block 58. If the call is not terminated at decision block 58, then it is determined if another applet is called or accessed at decision block 59. If no other applet is called or accessed at decision block 59, then the method 50 returns to decision block 58. If another applet or is accessed or called at decision block 59, then the method 50 returns to decision block 54 as shown. If the call is terminated at decision block 56, then the mobile phone device can be returned to a default normal operation at step 60.

Thus, by use of PhoneLets and the PhoneLet Manager, a user can customize the functionality of their communication device and possibly the functionality of the communication device being communicated with based upon who the communicating parties are, how the parties are communicating, and where the communicating parties are communicating from. Generally, a user can program a particular PhoneLet to make the communication device function in a manner indicative of the partying calling. For example, if a girlfriend calls, the user can program a particular PhoneLet associated with the girlfriend to display hearts and flowers on the communication device and play a love song in the background if desired. Alternatively, if a boss is calling, a pointy-haired character from the Dilbert cartoon series can be displayed with programmed static added in the background. If a short message is being sent for example to a pager associated with a particular PhoneLet, none of the background music and extraneous data used for wallpaper would likely be sent, but the PhoneLet could possibly make the pager ring with a distinct alert if the pager accepts data generated from the PhoneLet. If a fax is being sent from the communication device, the PhoneLet could be programmed to generate a cover sheet with the user's name and a date stamp as a default.

With respect to customizing the functionality of the communication device being communicated with, the party receiving calls must accept programming of their stored PhoneLets dynamically. Although such a feature may potentially pose a security breach, such a breach can be limited by providing only limited access and programmability. For example, using the PhoneLet Manager, a user can enable receipt of data for programming of a particular PhoneLet associated with a particular caller. In such an instance, if authorized by the receiving party, the caller ID associated with a particular caller can enable different wallpapers on the receiving party's display based upon the location of where the caller is calling from. If the calling party has a GPS device and they are in Florida, then a receiving party in Chicago might be able to see an Miami Dolphins insignia on their wallpaper backsplash while speaking to the calling party. If the receiving party in Chicago also has a GPS device, then the calling party in Florida might be able to see a picture of a Chicago Bear insignia on their backsplash. As the party in Chicago travels through the campus of a particular university in the Chicago area, the calling party might be able to see another picture, possibly of a corresponding college mascot on the backspash.

In light of the foregoing description of the invention, it should be recognized that the present invention can be realized in hardware, software, or a combination of hardware and software. A method and system for an Smart Phonebook in a communication device according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the methods described herein, is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which, when loaded in a computer system, is able to carry out these methods. A computer program or application in the present context means any expression, in any language, code or notation, of a set of instructions intended to cause a system having an information processing capability to perform a particular function either directly or after either or both of the following a) conversion to another language, code or notation; b) reproduction in a different material form.

Additionally, the description above is intended by way of example only and is not intended to limit the present invention in any way, except as set forth in the following claims.

What is claimed is:

1. A communication device having a smart phonebook, comprising:
a transceiver;
a memory having at least one phonebook data entry and at least one encapsulated data entry associated with the phonebook data entry; and
a processor coupled to the transceiver, wherein the processor is programmed to dynamically customize at least one program running in the communication device and to dynamically customize data associated with the at least one program based on the calling up of the at least one phonebook data entry and based on the at least one encapsulated data entry.

2. The communication device of claim 1, wherein the communication device further comprises a display coupled to the processor.

3. The communication device of claim 2, wherein the communication device further comprises graphical user interface for editing the at least one phonebook data entry and the at least one encapsulated data entry.

4. The communication device of claim 1, wherein the phonebook data entry is a Java-based application called a Phonelet.

5. The communication device of claim 4, wherein the Phonelet encapsulates at least one or more among a user interface, application logic for the communication device, data for making calls, data for receiving calls, data for sending messages, data for receiving messages, data for initiating a 3-way call, data for receiving a 3-way call, data for initiating an interconnect call, data for receiving an interconnect call, data for initiating a dispatch call, data for receiving a dispatch call, data for exchanging business card information, and data for synchronizing.

6. A smart phonebook for use in a communication device, comprising:
an application used as an entry for each separate phonebook entry in the smart phonebook; and
a smart phonebook manager having a graphical user interface enabling at least one or more of the functions selected from the group comprising adding an entry, deleting an entry, sorting a plurality of entries, updating an entry, sending an entry to another communication device, receiving an entry from another communication device, synchronizing an entry with another device, searching an entry by fields and attributes, starting an entry to make a call, starting an entry when receiving a call, starting a call forwarding among a plurality of entries, and starting a multi-way conference call among a plurality of entries.

7. The smart phonebook of claim 6, wherein the application used as the entry is a Java application designated a phonelet and the smart phonebook manager is designated a phonelet manager.

8. The smart phonebook of claim 6, wherein the function of synchronizing an entry with another device comprises the function of synchronizing an entry with at least one other device selected from the group of a server, a desktop computer running a desktop application, and a mobile communication device via packet data.

9. The smart phonebook of claim 6, wherein the function of searching fields and attributes comprises searching by at least one or more field or attribute selected from the group comprising name, phone number, dispatch identification, internet protocol address and email address.

10. The smart phonebook of claim 6, wherein the function of starting an entry when receiving a call comprises the function of starting an entry when receiving a call having a predetermined caller identification number.

11. The smart phonebook of claim 6, wherein the application further includes at least one function selected from the group of functions comprising starting an interconnect call, receiving an interconnect call when notified by the smart phonebook manager, starting a dispatch call, receiving a dispatch call when notified by the smart phonebook manager, sending an email, receiving an email when notified by the smart phonebook manager, sending a short message, receiving a short message when notified by the smart phonebook manager, call forwarding to another entry, and receiving a call forwarding from another entry when requested.

12. A method of using a smart phonebook for a communication device, comprising the steps of:
creating a application as an entry for each separate phonebook entry in the smart phonebook; and
accessing a smart phonebook manager having a graphical user interface enabling at least one or more of the functions selected from the group comprising adding an entry, deleting an entry, sorting a plurality of entries, updating an entry, sending an entry to another communication device, receiving an entry from another communication device, synchronizing an entry with another device, searching an entry by fields and attributes, starting an entry to make a call, starting an entry when receiving a call, starting a call forwarding among a plurality of entries, and starting a multi-way conference call among a plurality of entries.

13. The method of claim 12, wherein the application used as the entry is a Java application designated a phonelet and the smart phonebook manager is designated a phonelet manager.

14. The method of claim 12, wherein the step of synchronizing an entry with another device comprises the step of synchronizing an entry with at least one other device selected from the group of a server, a desktop computer running a desktop application, and a mobile communication device via packet data.

15. The method of claim 12, wherein the step of searching fields and attributes comprises the step of searching by at least one or more field or attribute selected from the group comprising name, phone number, dispatch identification, internet protocol address and email address.

16. The method of claim 12, wherein the step of starting an entry when receiving a call comprises the step of starting an entry when receiving a call having a predetermined caller identification number.

17. The method of claim 12, wherein the method further comprise at least one step selected from the group of steps comprising starting an interconnect call, receiving an interconnect call when notified by the smart phonebook manager, starting a dispatch call, receiving a dispatch call when notified by the smart phonebook manager, sending an email, receiving an email when notified by the smart phonebook manager, sending a short message, receiving a short message when notified by the smart phonebook manager, call forwarding to another entry, and receiving a call forwarding from another entry when requested.

18. A method of customizing mobile phone device functionality based upon peer-to-peer coupling using a Java-based smart phonebook, comprising the steps of:
receiving a call accessing a Java-based applet associated with the call among a plurality of Java-based applets forming the Java-based smart phonebook; and
executing the Java-based applet to create a customized user interface, application logic, and data while the call associated with the Java-based applet is active.

19. The method of customizing of claim 19, wherein the step of executing the Java-based applet creates a customized graphical user interface having a specified wallpaper associated with the Java-based applet.

20. The method of customizing of claim 19, wherein the step of executing the Java-based applet creates a customized ergonomic functionality for the mobile phone device.

21. The method of customizing of claim 19, wherein the method further comprises the step of accessing a default Java-based applet when no Java-based applet associated with the call exist among the plurality of Java-based applets forming the Java-based smart phonebook.

22. The method customizing of claim 19, wherein the step of receiving a call comprises the step selected from the group of steps comprising extracting data from caller identification information when receiving a phone call and extracting data from user input when a user is attempting to initiate a phone call.

23. The method of customizing of claim 19, wherein the method further comprises the step of returning the mobile phone device to a default normal operation upon termination of the call.

24. A machine readable storage, having stored thereon a computer program having a plurality of code sections executable by a machine for causing the machine to perform the steps of:
creating an application as an entry for each separate phonebook entry in a smart phonebook for the machine; and
accessing a smart phonebook manager with a graphical user interface of the machine enabling at least one or more of the functions selected from the group comprising adding an entry, deleting an entry, sorting a plurality of entries, updating an entry, sending an entry to another communication device, receiving an entry from another communication device, synchronizing an entry with another device, searching an entry by fields and attributes, starting an entry to make a call, starting an entry when receiving a call, starting a call forwarding among a plurality of entries, and starting a multi-way conference call among a plurality of entries.

25. The machine readable storage of claim 24, wherein the computer program further causes the machine to perform at least one step selected from the group of steps comprising starting an interconnect call, receiving an interconnect call when notified by the smart phonebook manager, starting a dispatch call, receiving a dispatch call when notified by the smart phonebook manager, sending an email, receiving an email when notified by the smart phonebook manager, sending a short message, receiving a short message when notified by the smart phonebook manager, call forwarding to another entry, and receiving a call forwarding from another entry when requested.

26. A machine readable storage, having stored thereon a computer program having a plurality of code sections executable by a machine for causing the machine to perform the steps of:
receiving a call accessing a Java-based applet associated with the call among a plurality of Java-based applets forming a Java-based smart phonebook;
executing the java-based applet to create a customized user interface, application logic, and data while the call associated with the Java-based applet is active; and
returning the machine to a default normal operation upon termination of the call.
